(19) United States
(12) Patent Application Publication
(10) Pub. No.: US 2015/0373280 A1
(43) Pub. Date: Dec. 24, 2015

(54) ALGORITHM FOR PRE-PROCESSING OF VIDEO EFFECTS

(71) Applicant: Sony Corporation, Tokyo (JP)

(72) Inventor: Martin DANIELSSON, Lund (DE)

(21) Appl. No.: 14/309,982

(22) Filed: Jun. 20, 2014

(51) Int. Cl. H04N 5/262

(52) U.S. Cl. CPC H04N 5/262

(57) ABSTRACT

A system and method of processing a video decode contents of a video container into a sequence of frames, and apply a video effect to each frame in the sequence of frames to produce corresponding modified frames. A sequence of differential frames is determined based on a comparison of the sequence of frames and the corresponding modified frames. A prediction operation is performed to the sequence of differential frames to produce a sequence of inter frames.

### TECHNICAL FIELD OF THE INVENTION

The technology of the present disclosure relates generally to electronic devices and, more particularly, to a system and method for efficiently pre-processing video effects for a video track on mobile devices.

### BACKGROUND

Electronic devices, such as mobile phones, cameras, music players, notepads, etc., are becoming increasingly popular. For example, mobile telephones, in addition to providing a means for voice communications with others, provide a number of other features, such as text messaging, email, camera functions, the ability to execute applications, etc.

A popular feature of electronic devices, such as mobile telephones, is their ability to create and play videos. With the ever advancing quality of photographic images created using portable electronic devices, users no longer need to carry a separate “dedicated” camera to capture images and/or videos of special moments.

To enhance the image quality of movie files, video post-processing technology, such as the X-REALITY™ video processing engine or other processing technology, can be applied to the video file. While such post-processing improves image quality, it can have drawbacks, particularly on mobile devices. More particularly, such processing methodologies tend to be processor intensive and thus can consume a significant amount of power, resulting in shorter battery life for the mobile device. Further, from a performance standpoint on mobile devices it can be difficult to upscale to 4K video (ultra high-definition) or higher resolution, or to 60 frames-per-second (FPS) or higher frame rate, and due to performance limitations the most advanced algorithms typically are not implemented on mobile devices.

Since certain processing algorithms do not depend on the environment (e.g., lighting conditions), it can be advantageous to pre-process the video (as opposed to processing the video in real-time as the video is being played). Such pre-processing would enable the video file to be off-loaded to another processing device, such as a cloud server, processed by the cloud server, and then returned to the mobile device. Since video processing would be performed by a cloud server or other device that likely has significantly more processing power than the mobile device, state-of-the-art video processing algorithms can be utilized instead of simpler mobile versions of the same algorithms. However there are a number of problems that prevent such preprocessing approach.

For example, in some instances it may be undesirable to apply video processing to the video file, e.g., when using HDMI. Also, re-encoding the processed video may introduce additional compression artifacts, and the re-encoding process may undo some of the improvements that the video processing technology introduced. Further, the re-encoding process is very time consuming, thus making such option unattractive for the casual user.

### SUMMARY

The present disclosure provides a system and method for pre-processing video tracks in an efficient manner. In this regard, a separate effect track is created that describes how the original video is to be modified in accordance with a particular video processing methodology. The effect track is appended to the original video container that stores the original video track and thus the original video track remains unchanged. In this manner, the original video track can readily be played without application of the effects (if so desired). Alternatively, if application of the video effects is desired, the effect file can easily be applied to the original video track to produce a modified video track that includes the effects.

According to one aspect of the invention, a computer-implemented method of processing a video includes: decoding contents of a video container into a sequence of frames; applying a video effect to each frame in the sequence of frames to produce a sequence of modified frames; determining a sequence of differential frames based on a comparison of the sequence of frames and the sequence of modified frames; and using a processor to perform a prediction operation to the sequence of differential frames to produce a sequence of inter frames.

According to one aspect of the invention, the method includes determining a sequence of residual frames based on a comparison of the sequence of differential frames and the inter frames.

According to one aspect of the invention, determining a sequence of residual frames includes subtracting the contents of each inter frame of the sequence of residual frames from a corresponding differential frame of the sequence of differential frames.

According to one aspect of the invention, the method includes encoding the sequence of residual frames to produce an effect track.

According to one aspect of the invention, the method includes appending the effect track to the video container.

According to one aspect of the invention, decoding includes extracting a video track from a video container, and decoding the extracted video to produce the sequence of video frames.

According to one aspect of the invention, determining a sequence of differential frames includes subtracting the contents of each modified frame of the sequence of frames from a corresponding frame of the sequence of frames.

According to one aspect of the invention, the method includes transferring the video file from a mobile device to a cloud server, and processing the video on the cloud server in accordance with the method described herein.

According to one aspect of the invention, decoding the contents of a video container into a sequence of frames includes obtaining motion vectors for at least some frames in the sequence of frames.

According to one aspect of the invention, decoding the contents of a video container into a sequence of frames includes decoding the video into a sequence of YUV frames.

According to one aspect of the invention, the video container comprises at least one of an MP4 container, an AVI container or an MPEG container.

According to one aspect of the invention, applying a video effect comprises using a video processing engine.

According to one aspect of the invention, a system for processing video includes: a cloud server; and a mobile device operative to store and execute a video stored in a video container, wherein the mobile device is configured to transfer the video container to the cloud server, the cloud server including logic configured to decode contents of a video container into a sequence of frames, logic configured to apply a video effect to each frame in the sequence of frames to produce a sequence of modified frames, logic configured to determine a sequence of differential frames based on a comparison of the sequence of frames and the sequence of modified frames, and logic configured to perform a prediction operation to the sequence of differential frames to produce a sequence of inter frames.

According to one aspect of the invention, the cloud server includes logic configured to determine a sequence of residual frames based on a comparison of the sequence of differential frames and the inter frames.

According to one aspect of the invention, the logic configured to determine a sequence of residual frames includes logic configured to subtract the contents of each inter frame of the sequence of residual frames from a corresponding differential frame of the sequence of differential frames.

According to one aspect of the invention, the cloud server includes logic configured to encode the inter frames to produce an effect track.

According to one aspect of the invention, the cloud server includes logic configured to append the effect track to the video container.

According to one aspect of the invention, the logic configured to decode contents of a video container into a sequence of frames includes logic configured to extract a video track from the video container, and decode the extracted video to produce the sequence of video frames.

According to one aspect of the invention, the logic configured to determine a sequence of differential frames includes logic configured to subtract the contents of each modified frame of the sequence of frames from a corresponding frame of the sequence of frames.

According to one aspect of the invention, the cloud server includes logic configured to receive the video file from a mobile device, and process the video on the cloud server.

According to one aspect of the invention, the logic configured to decode the contents of the video container into a sequence of frames includes logic configured to obtain motion vectors for at least some frames in the sequence of frames.

According to one aspect of the invention, the logic configured to decode the contents of the video container into a sequence of frames includes logic configured to decode the video into a sequence of YUV frames.

According to one aspect of the invention, the video container comprises at least one of an MP4 container, an AVI container or an MPEG container.

According to one aspect of the invention, the logic configured to apply the video effect comprises logic configured to use a video processing engine.

To the accomplishment of the foregoing and the related ends, the device and method comprises the features hereinafter fully described in the specification and particularly pointed out in the claims, the following description and the annexed drawings setting forth in detail certain illustrative embodiments, these being indicative, however, of but several of the various ways in which the principles of the invention may be suitably employed.

Although the various features are described and are illustrated in respective drawings/embodiments, it will be appreciated that features of a given drawing or embodiment may be used in one or more other drawings or embodiments of the invention.

### BRIEF DESCRIPTION OF THE DRAWINGS

FIG. 1 is a block diagram illustrating an effect file appended to a video container in accordance with the present disclosure.

FIG. 2 is a flow chart illustrating an exemplary method of processing a video in accordance with the present disclosure.

FIG. 3 is a simplified view of two frames that have been decoded from a video container.

FIG. 4 illustrates application of a video effect to the video data of FIG. 3 in accordance with the present disclosure.

FIG. 5 illustrates calculation of a delta between the modified video frames of FIG. 4 and the original video frames of FIG. 3 in accordance with the present disclosure.

FIG. 6 illustrates calculation of residual values of an effect track for one block of one frame in accordance with the present disclosure.

FIG. 7 illustrates the residual values or all blocks of two frames in accordance with the present disclosure.

FIG. 8 illustrates reconstruction of the effect track from the residual values and motion vectors.

FIG. 9 illustrates construction of a modified video block based on the original video block and the effect track corresponding to the video block in accordance with the present disclosure.

FIG. 10 illustrates a system for implementing the processing method in accordance with the present disclosure.

FIG. 11 illustrates an exemplary mobile device that can be used in the system of FIG. 10.

FIG. 12 illustrates an exemplary cloud server that can be used in the system of FIG. 10.

### DETAILED DESCRIPTION OF EMBODIMENTS

A system and method in accordance with the present disclosure will be described with reference to the drawings, where like reference numerals are used to refer to like elements throughout. It will be understood that the figures are not necessarily to scale.

While embodiments in accordance with the present disclosure relate, in general, to the field of electronic devices, for the sake of clarity and simplicity the embodiments outlined in this specification are described in the context of mobile phones. It should be appreciated, however, that features described in the context of mobile phones are also applicable to other mobile electronic devices.

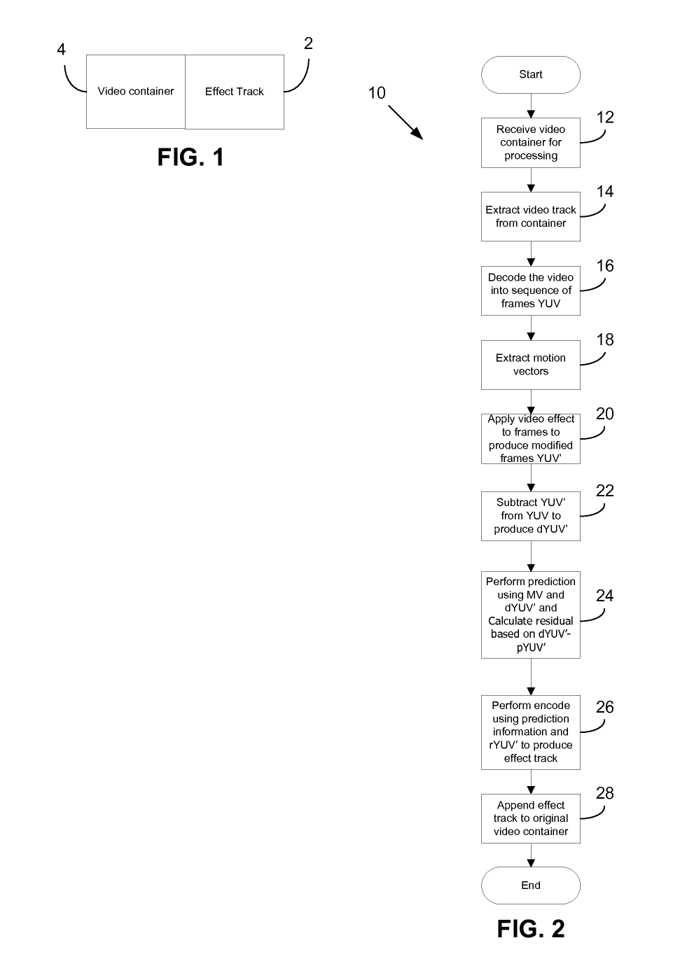

In accordance with the present disclosure, a system and method are provided for pre-processing video files in an efficient manner that provides improved flexibility over conventional video processing methodologies. More specifically, and with reference to FIG. 1, an effect track 2 is created based on a desired video processing methodology, and the effect track 2 is appended to the original video container 4. Since the effect track 2 is appended to the video container 4, the data corresponding to the original video track in the video container is unaltered. Thus, the original video track can easily be played without application of the effect track 2, e.g., by simply playing the original unaltered the video track. Alternatively, the modified version of the video (i.e., a version in which the effect is applied) can be played by applying the effect track 2 to the video track stored in the container 4.

In accordance with the present disclosure, a video track is extracted from a video container and decoded into a plurality of frames. Each frame then is divided into a plurality of blocks along with a corresponding motion vector that defines a change from one block relative to another block of a reference frame. A desired video effect then is applied to each pixel of each block, and a residual is then calculated based on the difference between pixel values in the original unaltered block and pixel values in the altered block. A prediction is made for each block using the previously obtained motion vectors and the altered blocks. The frame resulting from the prediction then is encoded along with the motion vectors to produce the effect track, which is appended to the original video container. Good compression can be achieved since redundancy is significantly reduced after the prediction step (assuming a good prediction).

Referring now to FIG. 2, a flow diagram 10 is provided illustrating exemplary steps for processing a video track in accordance with the present disclosure. The flow diagram includes a number of process blocks arranged in a particular order. As should be appreciated, many alternatives and equivalents to the illustrated steps may exist and such alternatives and equivalents are intended to fall with the scope of the claims appended hereto. Alternatives may involve carrying out additional steps or actions not specifically recited and/or shown, carrying out steps or actions in a different order from that recited and/or shown, and/or omitting recited and/or shown steps. Alternatives also include carrying out steps or actions concurrently or with partial concurrence.

Beginning at step 12, a video container is obtained that includes a video track to be processed. The video container may be any conventional container known in the art, non-limiting examples of which include MP4, MPEG and AVI containers. The video container may be obtained, for example, via a video function on a mobile device or by transferring the container from an external source (e.g., a memory card, the internet, etc.) to the mobile device. In one embodiment the video container is transferred to a cloud server for subsequent processing, and in another embodiment the video container is processed on the mobile device.

Next at block 14 the video track within the video container is extracted, and at block 16 the extracted video track is decoded into a sequence of frames. For example, the video track may be decoded into a sequence of YUV frames, where YUV is a color space used as part of a color image pipeline. While the present example is illustrated using a YUV color space, other color spaces may be used without departing from the scope of the invention.

Moving now to block 18, motion vectors MV are extracted from the sequence of frames. As will be understood by one having ordinary skill in the art, a motion vector is a two-dimensional vector that provides an offset from the coordinates in a decoded image (frame) to coordinates in a reference image (frame). Put another way, a motion vector represents a block (e.g., a macroblock) in a frame based on a position of the block (or similar block) in another frame (the “another frame” typically referred to as a “reference frame”).

Next at block 20 a video effect is applied to each frame in the sequence of frames to produce corresponding modified frames, the modified frames being referred to as YUV′. In one embodiment the applied video effect utilizes the X-REALITY™ video processing engine. However, the video effect may be based on any video processing engine that is preferred by the user.

For each frame in the sequence a differential sequence of frames dYUV′ is determined based on a comparison of the original sequence of frames and the corresponding modified frames as indicated at block 22. In this regard, the differential sequence may be obtained by subtracting the contents of each modified frame of the sequence of modified frames (YUV′) from the contents of the original frame of the sequence of original frames (YUV).

Next at block 24, an inter frame prediction is performed using the previously derived motion vectors MV and the differential sequence of frames dYUV′ to produce respective inter frames. An inter frame is a frame in a video compression stream that is expressed in terms of one or more neighboring frames. In inter frame prediction, a coded frame is divided into blocks (e.g., macroblocks) and an encoder attempts to find a block similar to the block being encoded on a previously encoded frame (a reference frame) using a block matching algorithm. The result of the prediction step is a sequence of frames pYUV′. A residual rYUV′ is calculated by subtracting pYUV′ from dYUV′. The residual then is encoded along with the motion vectors, which point to the position of the matching block in the reference frame, to form the effect track as indicated at block 26. The effect track then is appended to the original video container as indicated at block 28.

Since the original video track remains unchanged, upon playback the user can choose between the original video file and the modified video file, without the need to reprocess the data based on the selection. As a result, processing power is reduced thereby conserving battery life, and playback of the video file may appear smoother to the user.

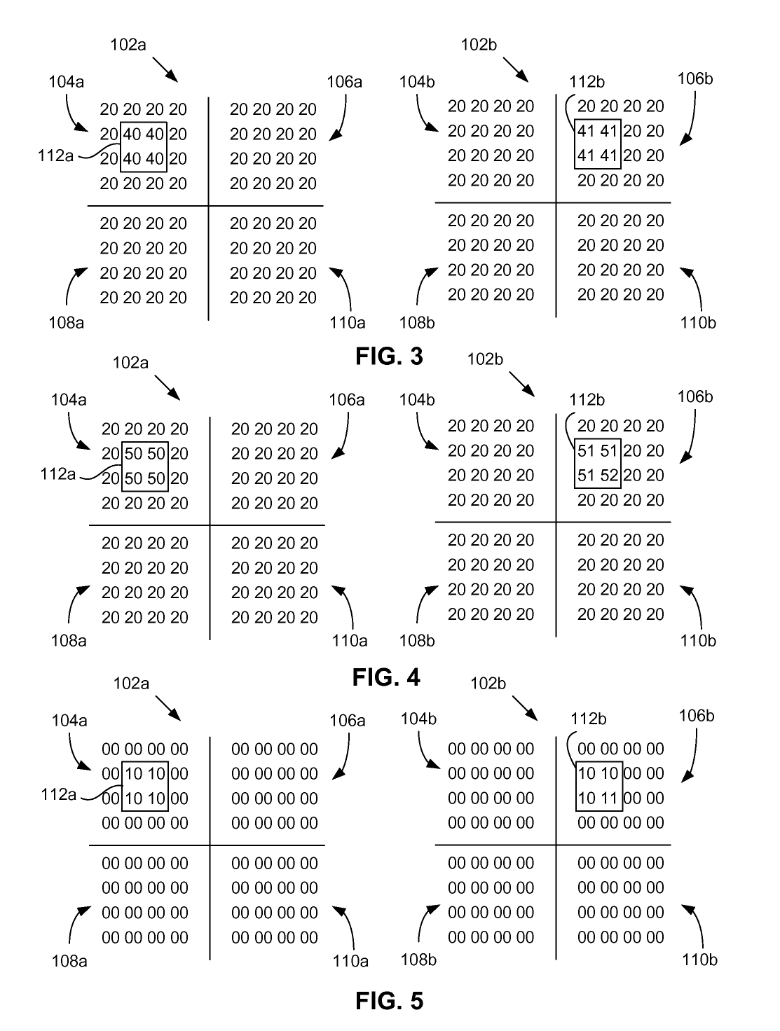

Execution of the method shown in FIG. 2 can be seen in a simplified example using two frames of 8×8 pixels divided into 4×4 blocks. More particularly, FIG. 3 illustrates the result of decoding the extracted video track into a sequence of frames. As seen in FIG. 3, the exemplary decoding process yields a first frame 102a of 8×8 pixel data and a second frame 102b of 8×8 pixel data. While in practice the pixel data would include three sets of data for each pixel, for simplicity only single entry is shown for each pixel.

The first and second frames 102a and 102b each can be divided into a first block 104a, 104b, a second block 106a, 106b, a third block 108a, 108b and a fourth block 110a, 110b, respectively, each block having 4×4 pixel data. As can be seen in FIG. 3, a difference between the first block 104a and the second block 106a of the first frame is identified in box 112a, while the third block 106 and fourth block 108 are the same. With respect to the second frame 102b, a difference between the first block 104b and the second block 106b is identified by box 112b, while the third and fourth blocks are the same.

From the respective decoded frames 102a and 102b, motion vectors can be derived as shown in step 18 of FIG. 2. For example, the first frame 102a does not have a prior frame for comparison purposes and therefore there are no motion vectors for the first frame 102a. For the second frame 102b, the first block 104b is identical to the second block 106a of the first frame 102a. Therefore, a motion vector represented as (4, 0) is produced, which represents moving four steps to the left relative to block 106a. Regarding the second block 106b of the second frame 102b, the data within the box 112b is similar to the data within the box 112a in the first block 104a of the first frame 102a. By moving the first block 104a three steps to the right a close approximation of the first block 104b of the second frame 102b is obtained. Thus, the motion vector for the second block 106b is (−3, 0). Regarding the third block 108b and fourth block 110b of the second frame 102b, these blocks are identical to the corresponding blocks 108a and 110a in the first frame 102a and thus the motion vectors are (0, 0) for both the third block 108b and fourth block 110b.

Next the video effect is applied to the respective frames (corresponding to step 20 of FIG. 2). For purposes of the present example, it is assumed that an effect is applied that enhances certain colors in order to obtain improved contrast, and that this effect adds a value of 10 to all values above 30. Also, it is assumed that another effect was applied that added a value of 1 to some of the data in the second block 106b of the second frame 102b. The resulting frames then are shown in FIG. 4, where the values in box 112a have been changed to 50 (10 added to values above 30) and the values in box 112b have been change to 51 and 52 (10 added to values above 30).

Next the differential between the frames prior to the application of the effect and after application of the effect is calculated (step 22 in FIG. 2). The result is shown in FIG. 5, where other than the data in boxes 112a and 112b, all data is zero.

An inter frame prediction then is performed on the differential frames of FIG. 5. As noted above, there are no motion vectors for the first frame 102a and therefore the first frame is not modified by the prediction step (step 24 of FIG. 2). For the second frame 102b, the residual values for each block are calculated using the previously obtained motion vectors. For example, and as described above with respect to FIG. 3, the data within the box 112b of the second block 106b of the second frame 102b is similar to the data within the box 112a of the first block 104a of the first frame 102a, but shifted three steps to the right. The motion vector (−3, 0) then can be applied to the first block 104a of the first frame 102a to approximate the second block 106b of the second frame 102b.

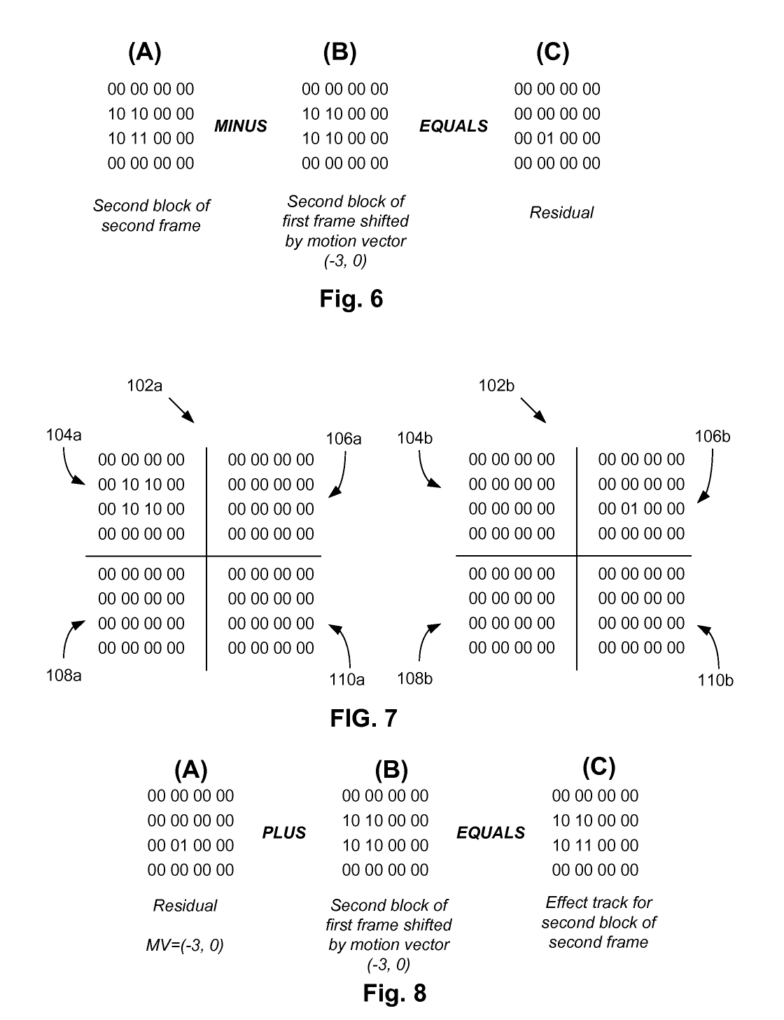

With reference to FIG. 6, a difference is obtained between the second block 106b for the second frame 102b (“A” in FIG. 6) and the same block 102b of the first frame 102a moved three spaces to the right based on the motion vector (−3, 0) (“B” in FIG. 6), yielding the prediction error (also referred to as residual values) shown in FIG. 6 (C).

After performing the same prediction methodology on the remaining blocks, the residual values shown in FIG. 7 are obtained. The data shown in FIG. 7 then can be encoded together with the previously derived motion vectors to produce an effect track (step 26 in FIG. 2). Since redundancy is significantly reduced in the residual, efficient compression of the effect track can be obtained, even in lossless mode. The effect track then can be appended to the original video container (step 28) (and returned to the mobile device if processing was performed on a cloud sever).

When the video container is executed on the mobile device, the decoder of the mobile device effectively performs the reverse of the above steps. The encoded effect track is extracted from the video container and decoded. Since the blocks of the first frame 102a do not have a reference frame, the first frame is decoded without reliance on motion vectors. With respect to the second frame 102b, the decoding example will be presented for the second block 106b of the second frame 102b. It will be appreciated that the other blocks of the second frame would be processed in a similar manner.

With reference to FIG. 8, the decoding process produces the residual shown in (A) along with the motion vector (−3, 0). The corresponding portion (as determined from the motion vector and shown in (B)) from the previously decoded first frame is added to the residual to produce the effect track shown in (C).

The steps for decoding the effect track can be performed in parallel with steps for decoding of the original video track. Decoding the original video track is known and, for sake of brevity, is not discussed herein. After the decoding process for the effect track and the original video is complete, the original video can be combined with the effect track to obtain the enhanced video.

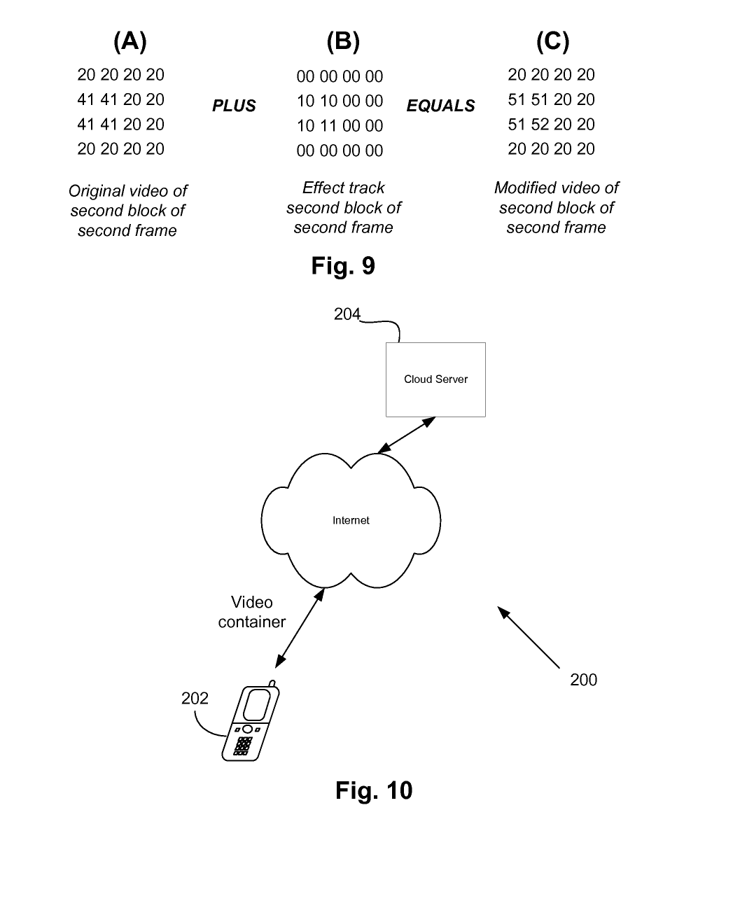

For example, and again using the second block 106b of the second frame 102b as basis for the example, the decoding process of the video track yields the second block 106b of the second frame 102b as shown in FIG. 9 (A), and also yields the effect track (B) (the effect track corresponding to the second block 106b of the second frame 102b). The effect track then can be added to the original video data to produce the video frame shown in FIG. 9 (C), which represents the final pixel data having the effect applied to the original video. In the event that the user does not wish to apply the effect, the steps can simply be skipped and the original data can be displayed.

Referring now to FIG. 10, illustrated is an exemplary system 200 for implementing the method in accordance with the present disclosure. The system includes a mobile device 202, such as a mobile phone or the like, and a cloud server 204. The mobile device 202 may communicate to the cloud server 204 via an internet connection established, for example, through a wireless communication means, e.g., a WiFi connection or other suitable communication means.

In operation, the mobile device 202 can transfer a video container 4 to the cloud server 204 along with instructions to process the video container using a particular processing engine, e.g., the X-REALITY™ video processing engine. The cloud server 204 then can process the video track stored in the container 4 in accordance with the present disclosure. Once processing is complete, the cloud server 204 can transfer the processed video container back to the mobile device 202, which can play the video with or without application of the effect to the video. Alternatively, and as noted above, the mobile device 202 can perform the processing steps, assuming sufficient processing power and/or battery life in the mobile device.

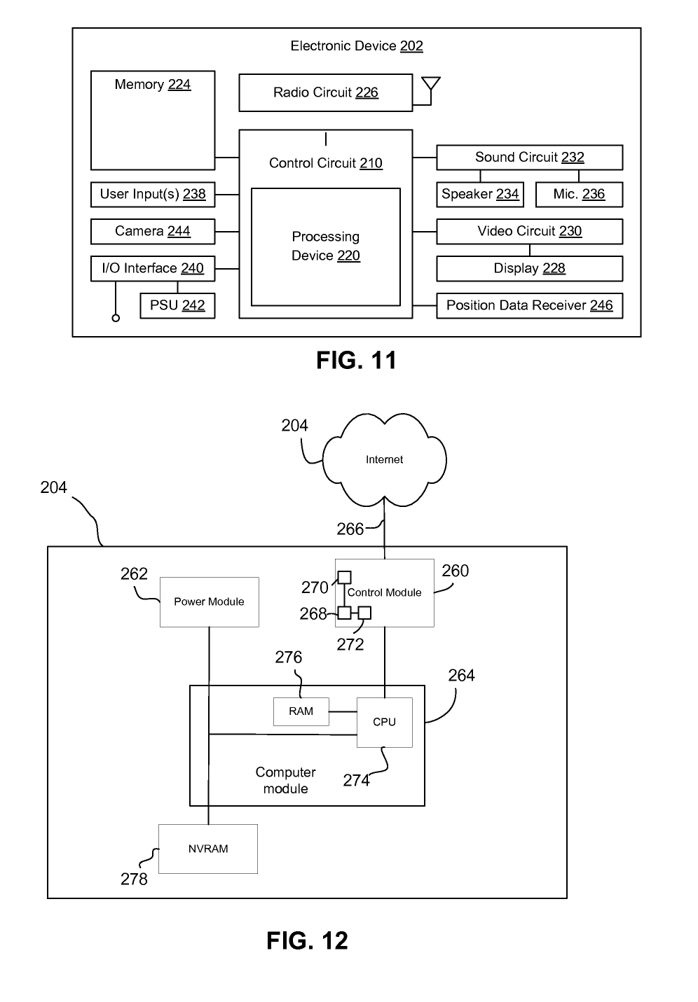

Referring to FIG. 11, schematically shown is an exemplary electronic device in the form of a mobile phone 202 that may be used in the system 200 in accordance with the present disclosure. The electronic device 202 includes a control circuit 210 that is responsible for overall operation of the electronic device 202. For this purpose, the control circuit 210 includes a processor 220 that executes various applications.

The processor 20 of the control circuit 210 may be a central processing unit (CPU), microcontroller or microprocessor. The processor 220 executes code stored in a memory (not shown) within the control circuit 210 and/or in a separate memory, such as a memory 224, in order to carry out operation of the electronic device 202. The memory 224 may be, for example, one or more of a buffer, a flash memory, a hard drive, a removable media, a volatile memory, a non-volatile memory, a random access memory (RAM), or other suitable device. In a typical arrangement, the memory 224 includes a non-volatile memory for long term data storage and a volatile memory that functions as system memory for the control circuit 210. The memory 224 may exchange data with the control circuit 210 over a data bus. Accompanying control lines and an address bus between the memory 224 and the control circuit 210 also may be present. The memory 224 is considered a non-transitory computer readable medium.

The electronic device 202 may include communications circuitry that enables the electronic device 202 to establish various wireless communication connections. In the exemplary embodiment, the communications circuitry includes a radio circuit 226. The radio circuit 226 includes one or more radio frequency transceivers and an antenna assembly (or assemblies). The electronic device 202 may be capable of communicating using more than one standard. Therefore, the radio circuit 226 represents each radio transceiver and antenna needed for the various supported connection types. The radio circuit 226 further represents any radio transceivers and antennas used for local wireless communications directly with an electronic device, such as over a Bluetooth interface.

The electronic device 202 is configured to engage in wireless communications using the radio circuit 226, such as voice calls, data transfers, and the like. Data transfers may include, but are not limited to, receiving streaming content, receiving data feeds, downloading and/or uploading data (including Internet content), receiving or sending messages (e.g., chat-style messages, electronic mail messages, multimedia messages), and so forth.

Wireless communications may be handled through a subscriber network, which is typically a network deployed by a service provider with which the user of the electronic device 202 subscribes for phone and/or data service. Communications between the electronic device 202 and the subscriber network may take place over a cellular circuit-switched network connection. Exemplary interfaces for cellular circuit-switched network connections include, but are not limited to, global system for mobile communications (GSM), code division multiple access (CDMA), wideband CDMA (WCDMA), and advanced versions of these standards. Communications between the electronic device 202 and the subscriber network also may take place over a cellular packet-switched network connection that supports IP data communications. Exemplary interfaces for cellular packet-switched network connections include, but are not limited to, general packet radio service (GPRS) and 4G long-term evolution (LTE).

The cellular circuit-switched network connection and the cellular packet-switched network connection between the electronic device 202 and the subscriber network may be established by way of a transmission medium (not specifically illustrated) of the subscriber network. The transmission medium may be any appropriate device or assembly, but is typically an arrangement of communications base stations (e.g., cellular service towers, also referred to as “cell” towers). The subscriber network includes one or more servers for managing calls placed by and destined to the electronic device 202, transmitting data to and receiving data from the electronic device 202, and carrying out any other support functions. As will be appreciated, the server may be configured as a typical computer system used to carry out server functions and may include a processor configured to execute software containing logical instructions that embody the functions of the server and a memory to store such software and related data.

Another way for the electronic device 202 to access the Internet and conduct other wireless communications is by using a packet-switched data connection apart from the subscriber network. For example, the electronic device 202 may engage in IP communication by way of an IEEE 802.11 (commonly referred to as WiFi) access point (AP) that has connectivity to the Internet.

The electronic device 202 may further include a display 228 for displaying information to a user. The displayed information may include the second screen content. The display 228 may be coupled to the control circuit 210 by a video circuit 230 that converts video data to a video signal used to drive the display 228. The video circuit 230 may include any appropriate buffers, decoders, video data processors, and so forth.

The electronic device 202 may further include a sound circuit 232 for processing audio signals. Coupled to the sound circuit 232 are a speaker 234 and a microphone 236 that enable a user to listen and speak via the electronic device 202, and hear sounds generated in connection with other functions of the device 202. The sound circuit 232 may include any appropriate buffers, encoders, decoders, amplifiers and so forth.

The electronic device 202 also includes one or more user inputs 238 for receiving user input for controlling operation of the electronic device 202. Exemplary user inputs include, but are not limited to, a touch input that overlays the display 228 for touch screen functionality, one or more buttons, motion sensors (e.g., gyro sensors, accelerometers), and so forth.

The electronic device 202 may further include one or more input/output (I/O) interface(s) 240. The I/O interface(s) 240 may be in the form of typical electronic device I/O interfaces and may include one or more electrical connectors for operatively connecting the electronic device 202 to another device (e.g., a computer) or an accessory (e.g., a personal handsfree (PHF) device) via a cable. Further, operating power may be received over the I/O interface(s) 240 and power to charge a battery of a power supply unit (PSU) 242 within the electronic device 202 may be received over the I/O interface(s) 240. The PSU 242 may supply power to operate the electronic device 202 in the absence of an external power source.

The electronic device 202 also may include various other components. For instance, a camera 244 may be present for taking digital pictures and/or movies. Image and/or video files corresponding to the pictures and/or movies may be stored in the memory 224. As another example, a position data receiver 246, such as a global positioning system (GPS) receiver, may be present to assist in determining the location of the electronic device 202.

Referring now to FIG. 12, a block diagram of an exemplary cloud server 204 is illustrated that may be used in accordance with the present disclosure. The cloud server 204 may include a control module 260 for controlling operations of the cloud server 204, a power module 262 for providing operational power to the cloud server 204, and at least one computer module 264 for running host provided services.

Both the control module 260 and power module 262 include all hardware necessary for making the appropriate electrical and data connections between them and the at least one computer module 264 and with each other as would be known to one skilled in the art. The control module 260 may comprise all components necessary for making connections with, using, and relaying data between the at least one computer module 264 and the internet through an external link 266, such as, inter alia, a processor 268, memory 270, and network controller and/or router 272 communicatively coupled via a bus. The control module 260 may function as a docking station for the at least one computer module 264. The control module 260 may act as the master controller of inputted and outputted data for the cloud server 204 and may do all of the actual interfacing with the internet and simply relay received data to and from the at least one computer module 264.

The at least one computer module 264 may further comprise a processor 274, a volatile memory 276 and a non-volatile memory 278 connected via a bus. The processor 274 may comprise a plurality of processors of reduced instruction set computer (RISC) architecture, such as an ARM processor, but may be of another type such as an x86 processor if design considerations warrant it.

The algorithm in accordance with the present disclosure may be stored in RAM 276 and/or NVRAM 278 of the computer module 264 and executed by the processor 264 of the cloud server 204 upon request by a user. While it is preferable that the algorithm be executed on the cloud server 204, the algorithm could be processed by the mobile device 202. In this regard, the algorithm may be stored in memory 224 of the mobile device 202 and executable by the processor 220. However, and as noted above, such processing tends to be computationally intensive and thus can reduce battery life on the mobile device, which is undesirable.

Although certain embodiments have been shown and described, it is understood that equivalents and modifications falling within the scope of the appended claims will occur to others who are skilled in the art upon the reading and understanding of this specification.

1. A computer-implemented method of processing a video, comprising:
decoding contents of a video container into a sequence of frames;
applying a video effect to each frame in the sequence of frames to produce a sequence of modified frames;
determining a sequence of differential frames based on a comparison of the sequence of frames and the sequence of modified frames; and
using a processor to perform a prediction operation to the sequence of differential frames to produce a sequence of inter frames.

2. The method according to claim 1, further comprising determining a sequence of residual frames based on a comparison of the sequence of differential frames and the inter frames.

3. The method according to claim 2, wherein determining a sequence of residual frames includes subtracting the contents of each inter frame of the sequence of residual frames from a corresponding differential frame of the sequence of differential frames.

4. The method according to claim 2,
further comprising encoding the sequence of residual frames to produce an effect track.

5. The method according to claim 4, further comprising appending the effect track to the video container.

6. The method according to claim 1, wherein decoding includes extracting a video track from a video container, and decoding the extracted video to produce the sequence of video frames.

7. The method according to claim 1, wherein determining a sequence of differential frames includes subtracting the contents of each modified frame of the sequence of frames from a corresponding frame of the sequence of frames.

8. The method according to claim 1, wherein decoding the contents of a video container into a sequence of frames includes obtaining motion vectors for at least some frames in the sequence of frames.

9. The method according to claim 1, wherein applying a video effect comprises using a video processing engine.

10. A system for pre-processing video, comprising:
a cloud server; and
a mobile device operative to store and execute a video stored in a video container, wherein the mobile device is configured to transfer the video container to the cloud server, the cloud server including
logic configured to decode contents of a video container into a sequence of frames,
logic configured to apply a video effect to each frame in the sequence of frames to produce a sequence of modified frames
logic configured to determine a sequence of differential frames based on a comparison of the sequence of frames and the sequence of modified frames, and
logic configured to perform a prediction operation to the sequence of differential frames to produce a sequence of inter frames.

11. The system according to claim 10, wherein the cloud server includes logic configured to determine a sequence of residual frames based on a comparison of the sequence of differential frames and the inter frames.

12. The system according to claim 11, wherein the logic configured to determine a sequence of residual frames includes logic configured to subtract the contents of each inter frame of the sequence of residual frames from a corresponding differential frame of the sequence of differential frames.

13. The system according to claim 10, wherein the cloud server includes logic configured to encode the inter frames to produce an effect track.

14. The system according to claim 10, wherein the cloud server includes logic configured to append the effect track to the video container.

15. The system according to claim 10, wherein the logic configured to decode contents of a video container into a sequence of frames includes logic configured to extract a video track from the video container, and decode the extracted video to produce the sequence of video frames.

16. The system according to claim 10, wherein the logic configured to determine a sequence of differential frames includes logic configured to subtract the contents of each modified frame of the sequence of frames from a corresponding frame of the sequence of frames.

17. The system according to claim 10, wherein the cloud server includes logic configured to receive the video file from a mobile device, and process the video on the cloud server.

18. The system according to claim 10, wherein the logic configured to decode the contents of the video container into a sequence of frames includes logic configured to obtain motion vectors for at least some frames in the sequence of frames.

19. The system according to claim 10, wherein the logic configured to decode the contents of the video container into a sequence of frames includes logic configured to decode the video into a sequence of YUV frames.

20. The system according to claim 10 wherein the logic configured to apply the video effect comprises logic configured to use a video processing engine.
